(19) United States
(12) Patent Application Publication
(10) Pub. No.: US 2017/0333269 A1
(43) Pub. Date: Nov. 23, 2017

(54) CHAIR WITH STAND-UP ASSISTANCE

(71) Applicant: Ko-Po Chen, Taichung City (TW)

(72) Inventor: Ko-Po Chen, Taichung City (TW)

(21) Appl. No.: 15/158,613

(22) Filed: May 19, 2016

(51) Int. Cl. A61G 5/14

(52) U.S. Cl. CPC A61G 5/14

(57) ABSTRACT

The chair includes a base member, a support member, at least a linkage member configured on the base member and to a bottom side of the support member in a movable manner, at least a first power assembly connected between the support member and the linkage member, and a second power assembly connected between the linkage member and the base member. The first power assembly provides an angle variation between the support member and the linkage member, whereas the second power assembly provides a separate angle variation between the linkage member and the base member. The chair provides both stand-up assistance and comfortable reclining, and has fewer components, less cost, more flexible and smooth linkage, and requires less power to operate.

### BACKGROUND OF THE INVENTION

### (a) Technical Field of the Invention

The present invention is generally related to chairs with stand-up assistance, and more particular to such a chair having fewer components, less cost, more flexible and smooth linkage, and requiring less power.

### (b) Description of the Prior Art

Usually a chair with stand-up assistance or the so-called lift chair has a linkage mechanism under the seat. The linkage mechanism tilts the seat forward for an angle so as to assists a user to a standing position with reduced burden to the knees. The linkage mechanism is usually powered by electricity so that the user can stand up from the chair without other's assistance, greatly enhancing the convenience of the user.

### SUMMARY OF THE INVENTION

A major objective of the present application is to provide a simplified linkage mechanism but capable of more flexible angle variation so as to fit various needs.

The chair includes a base member, a support member for supporting a user, at least a linkage member configured on the base member and to a bottom side of the support member in a movable manner, at least a first power assembly connected between the support member and the linkage member, and a second power assembly connected between the linkage member and the base member. The first power assembly provides an angle variation between the support member and the linkage member, whereas the second power assembly provides a separate angle variation between the linkage member and the base member. The chair according to the present invention therefore relies on a single linkage member to achieve flexible angle variation of the support member. The chair has fewer components, less cost, more flexible and smooth linkage, and requires less power to operate.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a chair with stand-up assistance according to an embodiment of the present invention.

FIG. 2 is another perspective diagram showing the chair with stand-up assistance of FIG. 1.

FIG. 2A is a perspective diagram showing a first power assembly of the chair with stand-up assistance of FIG. 1.

FIG. 3 is a profile diagram showing the chair with stand-up assistance of FIG. 1.

FIG. 4 is a profile diagram showing the chair with stand-up assistance of FIG. 1 when it is tilted forward.

FIG. 4A is a perspective diagram showing the chair with stand-up assistance of FIG. 4.

FIG. 5 is a profile diagram showing the chair with stand-up assistance of FIG. 1 when it is tilted backward.

FIG. 6 is a profile diagram showing the chair with stand-up assistance of FIG. 1 when it is raised.

FIG. 7 is another profile diagram showing the chair with stand-up assistance of FIG. 1 when it is tilted backward.

FIG. 8 is a perspective diagram showing a chair with stand-up assistance according to another embodiment of the present invention.

FIG. 9 is a profile diagram showing the chair with stand-up assistance of FIG. 8.

FIG. 10 is a profile diagram showing the chair with stand-up assistance of FIG. 8 when it is tilted backward.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

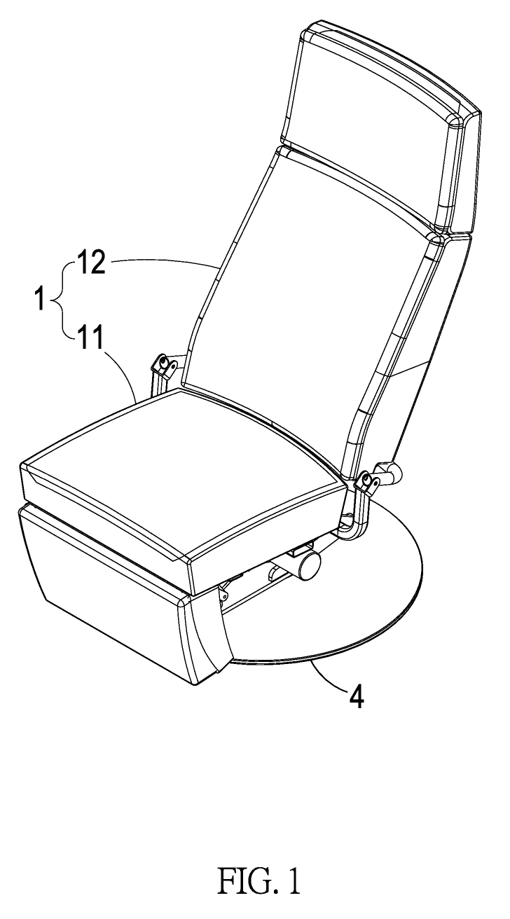

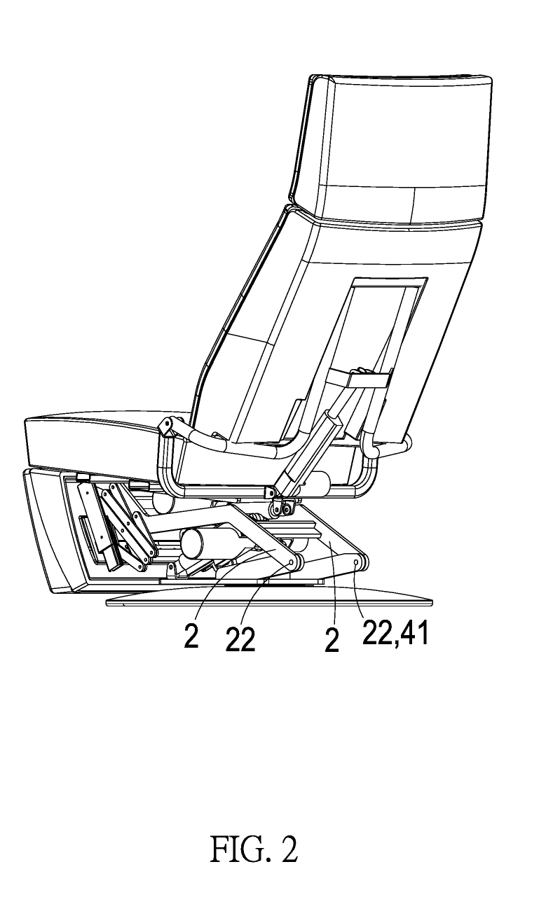

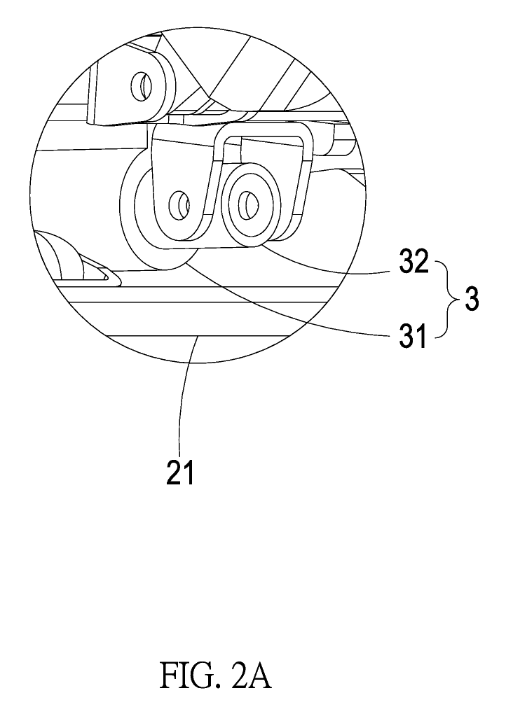

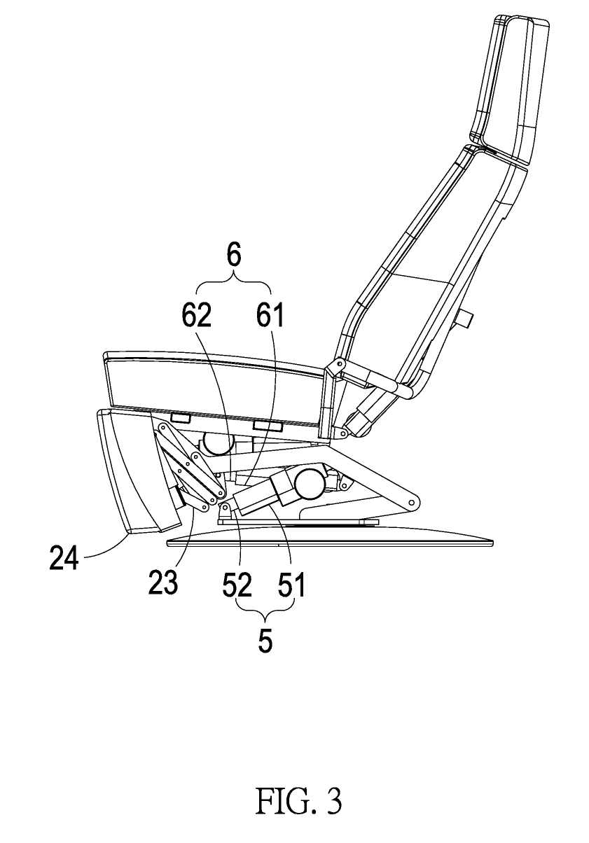

As shown in FIGS. 1 to 3, a chair with stand-up assistance according to an embodiment of the present invention includes the following components.

A support member 1 for supporting a user is provided. The support member 1 includes a seat element 11 for a user to sit on and a back support element 12 for the user to rest his/her back.

A linkage member 2 is configured to a bottom side of the support member 1 in a moveable manner. The linkage member 2 includes at least a reinforced rod 21. The moveable manner is one of rotation, swing, and slide.

At least a first power assembly 3 is connected between the support member 1 and the linkage member 2. The first power assembly 3 includes a first bushing element 31 and a first extension element 32 telescoping from the first bushing element 31 so as to provide angle variations between the support member 1 and the linkage member 2.

A base member 4 is provided for mounting the linking member 2. At least a coupling part 41 for connecting the linkage member 2 is provided.

At least a second power assembly 5 is connected between the linkage member 2 and the base member 4. The second power assembly 5 includes a second bushing element 51 and a second extension element 52 telescoping from the second bushing element 51 so as to provide angle variations between the linkage member 2 and the base member 4.

At least a connection element 22 is moveably configured along a side of the coupling part 41. The connection element 22 is joined to the linkage member 2. The linkage member 2 further includes an auxiliary linkage assembly 23 engaging a leg support element 24. A third power assembly 6 is connected to the auxiliary linkage assembly 23. The third power assembly 6 includes a third bushing element 61 and a third extension element 62 telescoping from the third bushing element 61 to engage the auxiliary linkage assembly 23 to expand or contract.

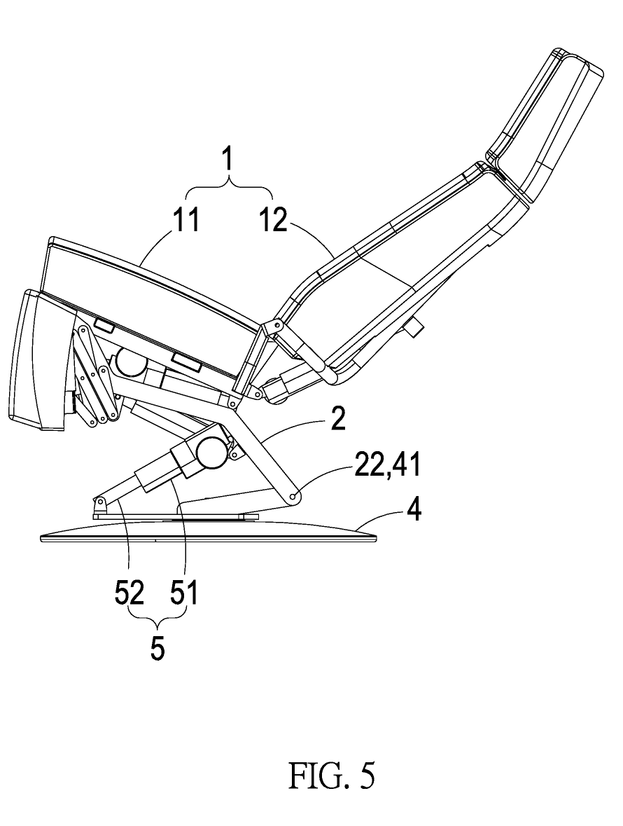

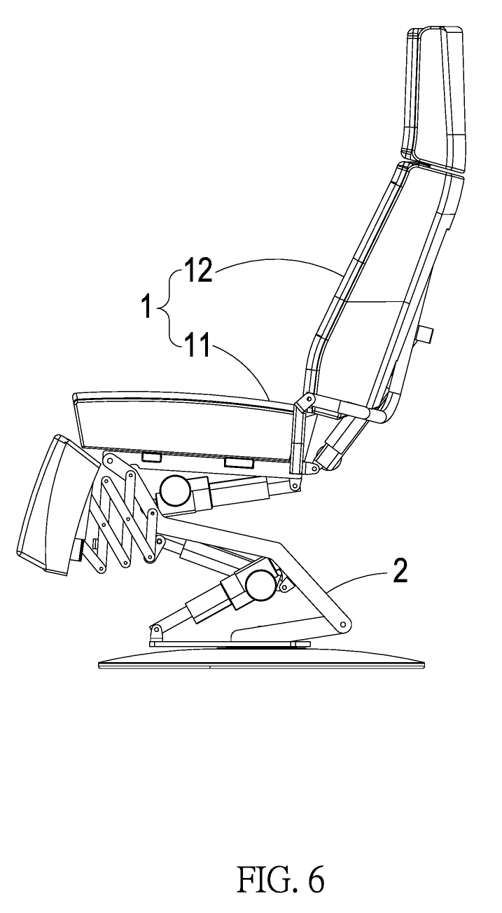

As shown in FIGS. 1 to 7, the first, second, and third power assemblies 3, 5, and 6 can be electrical, hydraulic, or pneumatic power sources providing expansion/contraction or rotation force. In the present embodiment, electrical power sources and expansion/contraction force are used as example, but the present invention is not limited as such. When the first power assembly 3 is actuated, the first extension element 32 is extended from the first bushing element 31. In the meantime, the first bushing element 31 pivots on the linkage member 2. The first extension element 32 therefore pushes the support member 1 to tilt forward. When the second power assembly 5 is actuated, the second extension element 52 is extended from the second bushing element 51. In the meantime, the second bushing element 51 pivots on the linkage member 2 and the second extension element 52 pushes the linkage member 2. Since the connection element 22 is moveably joined to the coupling part 41. The linkage member 2 therefore pivots on the base member 4. As such, the user is assisted to stand up from the support member 1 with reduced burden on the knees. When the second power assembly 5 is actuated alone, the support member 1 is tilted backward and the user can comfortably lie on the chair with little effort. The chair of the present invention therefore achieves various variations with a simplified mechanism, and provides not only stand-up assistance but also comfortable reclining.

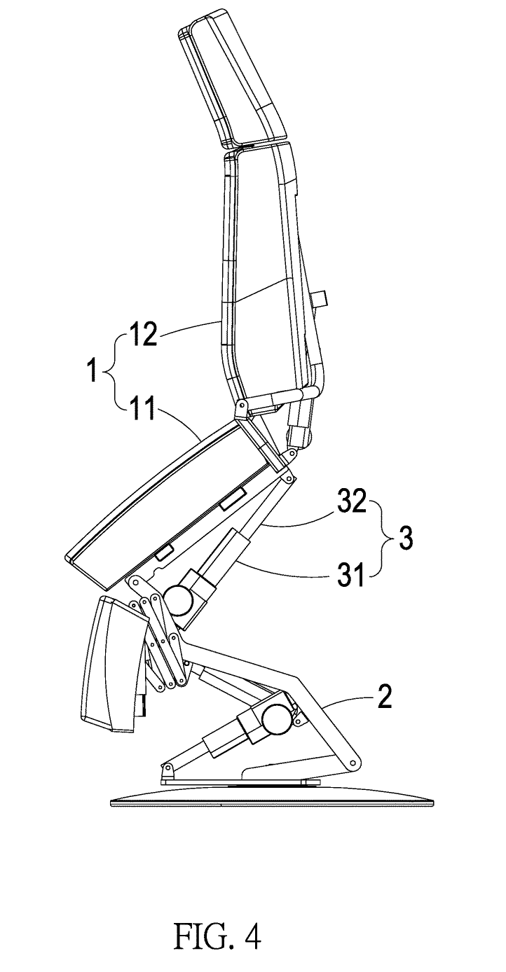

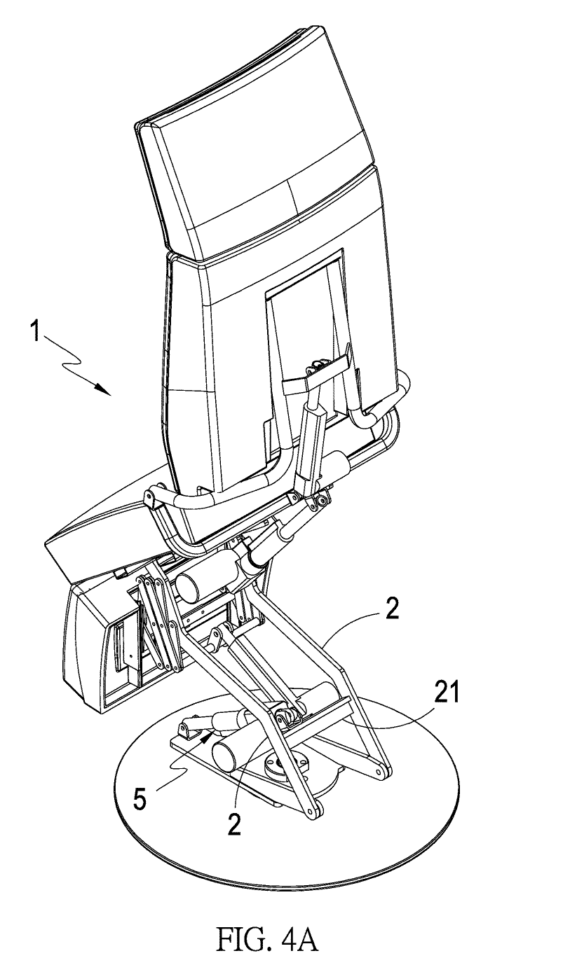

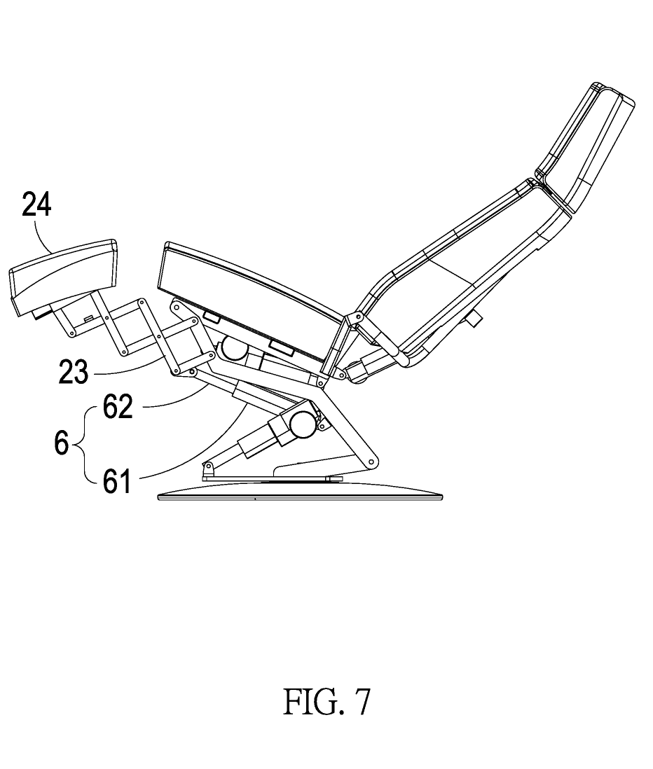

As illustrated in FIG. 4A, when the first and second power assemblies 3 and 5 are actuated together, both the linkage member 2 and the support member 1 are pivoted. The reinforced rod 21 enhances the strength of the linkage member 2 so that the linkage member 2 alone can achieve various variations. The configuration of the reinforced rod 21 sustains at least one power assembly (i.e., the first power assembly 3, the second power assembly 5, or the third power assembly 6). Therefore, the chair of the present invention achieves less cost, more flexible and smooth linkage, and requires less power to operate. As shown in FIG. 7, when the third power assembly 6 is actuated, the third extension element 62 is extended from the third bushing element 61 and pushes the auxiliary linkage assembly 23, which in turn engages the leg support element 24. The user therefore can rest his/her feet on the leg support element 24 while the chair is in the reclining position. As described, the first, second, and third power assemblies 3, 5, and 6 can be actuated separately, together in pairs, or altogether, so as to fulfill various requirements of the user.

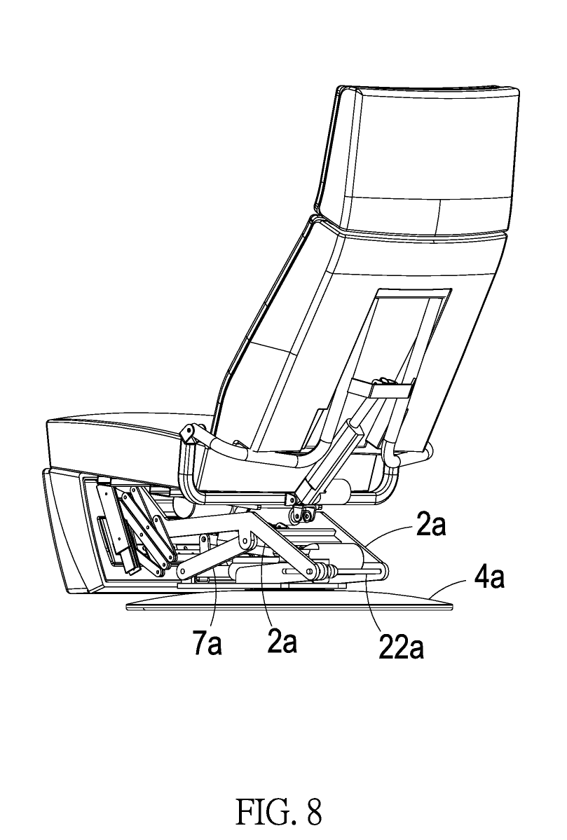

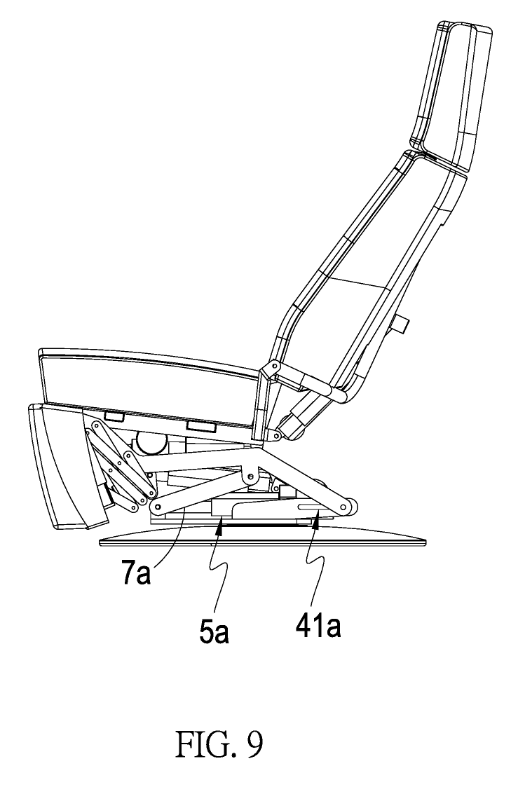

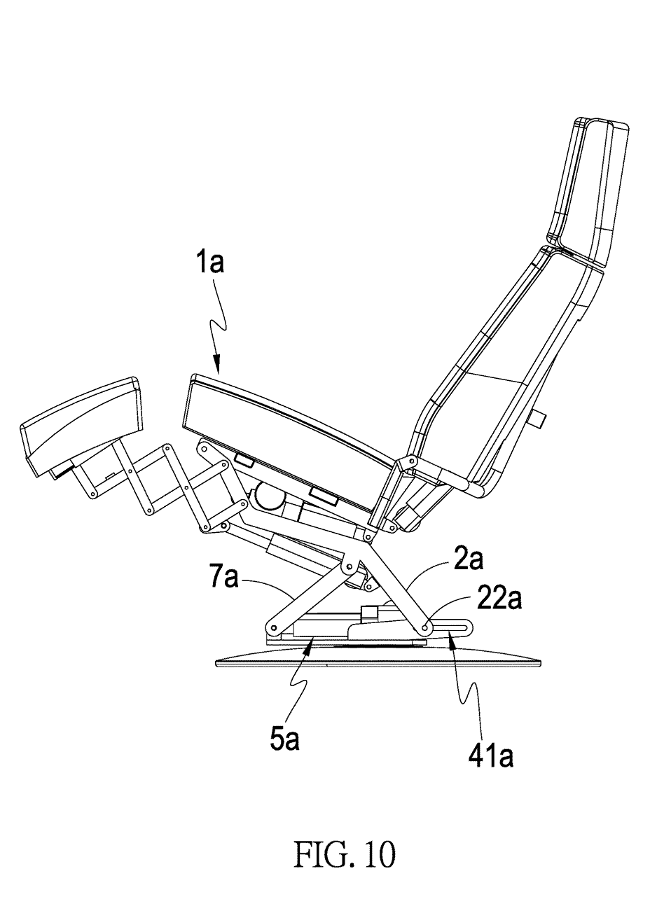

As shown in FIGS. 8 to 10, in another embodiment of the present invention, an addition pivot element 7a is connected between the base member 4a and the linkage member 2a. The pivot element 7a works together with the second power assembly 5a to provide angle variations between the base member 4a and the linkage member 2a. In the present embodiment, the coupling part 41a is moveably configured with the connection element 22a. When the second power assembly 5a is actuated, the pivot element 7a pivots on the base member 4a and the linkage member 2a. The second power assembly 5a pulls the connection element 22a to slide relative to the coupling part 41a, thereby achieving angle variations between the base member 4a and the linkage member 2a while the support member 1a is tilted backward.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A chair with stand-up assistance, comprising:
a base member;
a support member comprising a seat element for a user to sit on and a back support element for the user to rest his/her back;
a linkage member comprising a pair of generally linear beams in parallel whose front ends are hinged to a front section of the seat element and whose back ends are hinged to a back section of the base member through at least a connection element;
a first power assembly disposed between the pair of beams connected between the support member and the linkage member to provide an angle variation therebetween, where the first power assembly comprises a first bushing element and a first extension element telescoping from the first bushing element, the first bushing element is connected to front sections of the beams, and the first extension element is connected to a back section of the seat element so as to provide the angle variation between the support member and the linkage member; and
a second power assembly disposed between the pair of beams connected between the linkage member and the base member to provide an angle variation therebetween, where the second power assembly comprises a second bushing element and a second extension element telescoping from the second bushing element, the second bushing element is connected to middle section of the beams, and the second extension element is connected to a front section of the base member so as to move the linkage member and therefore the support member around the connection element to achieve the angle of variation between the linkage member and the base member.

2.-3. (canceled)

4. The chair according to claim 1, wherein the linkage member comprises a reinforced rod.

5.-6. (canceled)

7. The chair according to claim 1, wherein an auxiliary linkage assembly is moveably configured to the linkage member; the auxiliary linkage assembly connects and engages a leg support element; the auxiliary linkage assembly is connected to and engaged by a third power assembly.

8. The chair according to claim 7, wherein the third power assembly comprises a third bushing element and a third extension element telescoping from the third bushing element so as to engage the auxiliary linkage assembly.

9.-10. (canceled)
